(19) United States
(12) Patent Application Publication
(10) Pub. No.: US 2005/0111837 A1
(43) Pub. Date: May 26, 2005

(54) Method and kit for conducting marketing research using DVD technology

(76) Inventors: Christian Super, Cincinnati, OH (US); Meg Weigmann, Cincinnati, OH (US); Peter Rhodes, Cincinnati, OH (US); Alan Dean, Cincinnati, OH (US)

Correspondence Address: ANDERSON, KILL & OLICK, P.C., 1251 AVENUE OF THE AMERICAS, NEW YORK,, NY, 10020-1182, US

(21) Appl. No.: 10/723,821

(22) Filed: Nov. 24, 2003

(51) Int. Cl. H04N 5/781

(52) U.S. Cl. 386/125; 386/126

(57) ABSTRACT

A method and a kit for conducting marketing research in which respondents evaluate a program and commercials using DVD technology.

### BACKGROUND OF THE INVENTION

1. Field of the Invention

The present invention relates to a method and kit for conducting marketing research. In particular, the present invention relates to a method and a kit for conducting marketing research in which respondents evaluate a program and commercials using DVD technology.

2. The Prior Art

Marketing research tools such as surveys are known in the art.

U.S. Pat. No. 4,891,712 relates a method of conducting marketing research using a video tape.

This methodology requires that the tape be erased after it is played. Further, this invention does not permit the tape to be played out of order. It would be desirable to provide a marketing tool with greater flexibility and where the program is not destroyed so that follow-up questions can be asked.

### SUMMARY OF THE INVENTION

The present invention provides a method and a kit for conducting marketing research using DVD technology in which respondents are recruited to participate in market research evaluation of a program and enter a prize drawing. A package is sent to each respondent who agrees to participate. Each package includes a DVD containing a program and commercials to be evaluated and code numbers to access said program and said commercials on said DVD, said package further including instructions for respondents to read and prize drawing books to filled out by respondents. Secured codes are entered by said respondents for accessing said DVD in order to view said program and said commercials in said DVD in one sitting.

### BRIEF DESCRIPTION OF THE DRAWINGS

FIG. 1 is a flow chart of the present invention; and

FIG. 2 is a flow chart illustrating the operation of the DVD in accordance with the present invention.

### DETAILED DESCRIPTION OF THE PREFERRED EMBODIMENT

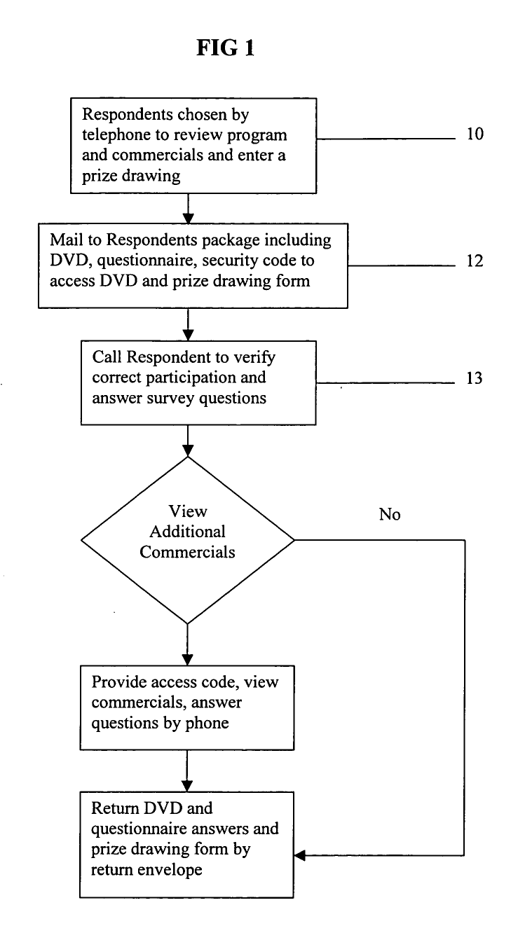

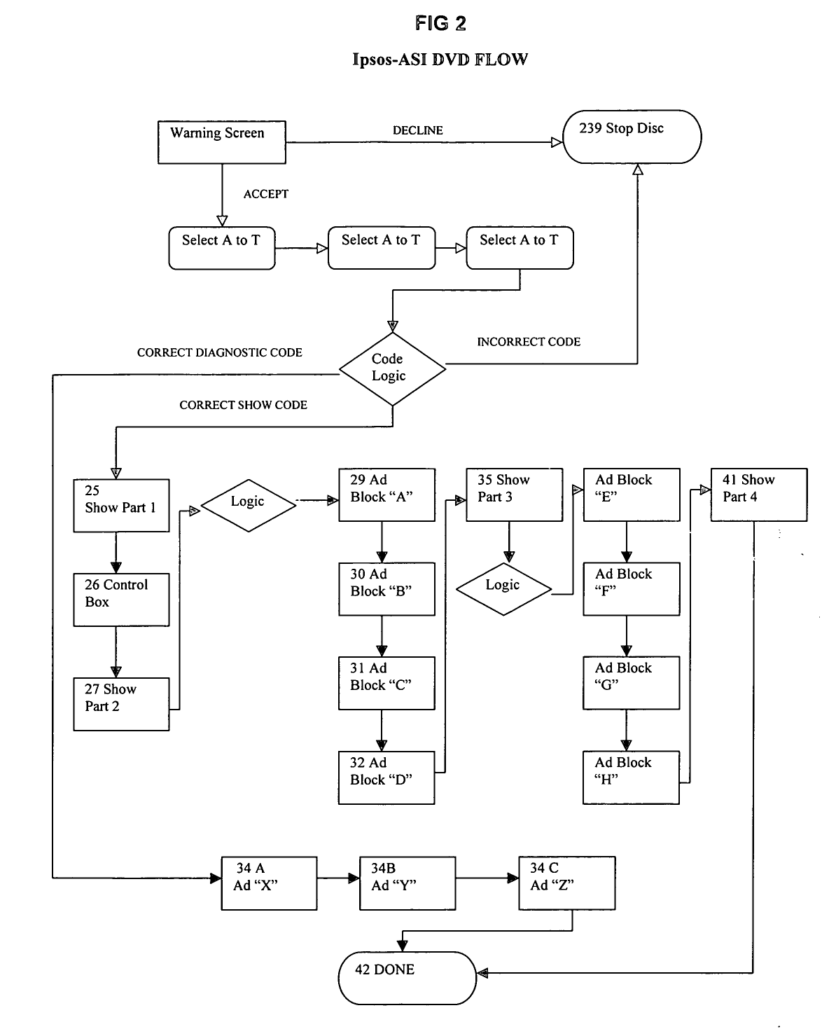

Referring to the drawings of FIGS. 1 and 2, FIG. 1 illustrates the operation of the present invention. In step 10 of FIG. 1, potential respondents are recruited, preferably by telephone, to evaluate a program such as a television program and commercials and also to enter a prize drawing contest program. Respondents are then sent a package containing a secured DVD that includes a program and commercials (see step 11 of FIG. 1). The package also includes prize drawing books and instructions. Respondents then access the DVD using the specific code supplied for the specific DVD sent and view the program and commercials in one sitting and answer a survey questionnaire included in the package. Respondents then fill out the prize drawing booklet (see step 12).

Each respondent is then called to verify correct participation and to answer survey questions. Such questions would typically include questions about the program viewed, when it was viewed, whether the questionnaire had been filled out, whether the show had been ever seen previously, whether the show was watched in its entirety, and whether the respondent left the room at any time during which the show was being played (step 13).

Respondents are then asked to view additional commercials on the DVD (step 14).

Respondents decide if they will continue participating by viewing these new commercials (step 15).

If respondents agree (step 15) then a new security code is provided to access the new commercials in the DVD. After viewing the commercials, the respondents are asked by telephone questions about these new commercials. The respondents then return the material as indicated in step 16.

If respondents disagree to continue, they return the DVD and written survey answers and prize drawing booklet in the preaddressed and postage paid enclosed envelope (step 16).

The DVD is programmed to be accessed by the security code that is indigenous to accessing the program stored on the DVD for viewing. The program can be replayed, but only from the beginning, and cannot be fast forwarded. This is to ensure that the respondent views it in one sitting in its entirety. Other commercials or other information may be contained on the DVD which require a different access code as illustrated in step 15 of FIG. 1.

FIG. 2 illustrates the flow path of the DVD's operation. The DVD has a security menu requiring specific codes to view material stored on the DVD as described above. Thus, as shown in FIG. 2, the menu has a warning screen requiring an input of the security code (21). Three code elements, preferably alpha-numerical, are inputted (22a, 22b and 22c). If they are determined to be correct (see 23) then the DVD plays the security code for the initial program and commercials (25) or the additional commercials (26).

FIG. 2 illustrates the flow path of the DVD's operation. The DVD has a security menu requiring a security code to view material stored on the DVD as described above. Thus, as shown in FIG. 2, the menu has a warning screen requiring an input of the security code (21). Three code elements, preferably alphabetical in the range of A through T, are inputted (22a, 22b and 22c). If they are determined to be correct (see 23), then the DVD plays the security code for the initial program and commercials (25) or the additional commercials (26).

If the inputted three lettered alphabetical security code is correct as a show code determined in step 23 of FIG. 2, then the first part of the program (part number 1) is displayed for viewing as indicated in step 25. If the code is incorrect, then the disc is stopped as shown in step 23a. If the inputted code is determined to be a correct diagnostic code in step 23, then advertisements x, y and z (in steps 34a, 34b and 34c, respectively) are displayed in sequence as shown in FIG. 2.

After step 26, where the control ad is displayed and viewed, the viewer next watches part number 2 of the show as indicated in step 27. Then, based on the inputted code, logic step 28 determines whether for that particular code which of ads A, B, C and D from blocks 29, 30, 31, 32, respectively, to display for that particular code. The choice may be one of demographics assigned to certain alphabetical codes so that the preferred demographic group views the advertisements targeted for them. The viewer next watches part number 3 of the show in step 35. Logic in step 36 determines which ads are to be viewed by the viewer based upon his initial inputted three letter alphabetical code from ads E, F, G, and H in steps 37, 38, 39 and 40, respectively. Part number 4 of the show is next viewed in step 41 and the viewing is completed (see step 42).

An additional feature of the present invention is the autoeject feature. In order to ensure that the data in the DVD is not copied for later viewing in violation of the rules for viewing the data for market research purposes, if the DVD is not placed in a regular DVD player but instead put into a PC connected drive, the PC will detect the file labeled autorun.inf. The PC must have Auto Play on at the time, which is the default condition in Windows, so most users will have this turned on.

Once the PC detects the file autorun.inf, the file will start the VB program start.exe. The purpose of the program is to ensure that DVD media, in accordance with survey rules, are only played in a standard DVD player, and not on a PC. This is to prevent copying the data for later viewing, and possibly invalidating the survey results of the present invention.

The program operates as follows: the PC detects the file autorun.inf, which then starts the executable start.exe. This program then causes the DVD (or CD) drive to open. The user is prompted to play the disc in a standard TV-connected DVD player.

A standard DVD player ignores the autorun.inf file and simply plays the DVD as normal.

The program is written in Visual Basic 6, although the invention is not limited to any particular program language.

The files on the target disc include: Start.exe and autorun.inf.

The commented source code and detailed design are described below:

The source files are: Cdopen.vbp; Cdopen.vbw; and Mainopen.form.

The detailed design is as follows:

In distributing test material on DVD, the user MUST play it on a regular DVD player. The user views it on a TV which is NOT on a PC-connected DVD drive. This is to prevent copying the DVD video files for later viewing. Thus, the program causes the disc to eject if the disc is put in a personal computer (PC)-connected drive. The autoplay on the client PC must be on. Since this is the default condition in Windows, most users will have this turned on.

Upon reading the disc, the PC detects the file autorun.inf. This file starts the VB program start.exe (the code is listed below).

The PC loops through the available drives to see if it is of type CD-ROM (4). Windows treats a DVD drive just like a CD-ROM drive. If the current drive returns type 4, then the PC checks to see if it is the drive with the disc in it. This is accomplished by checking for the existence of the file\start.exe. If it returns NO, then skip and move to the next drive. If YES, then an error is raised which halts processing and turns control over to the error routine.

The Error routine erropendrive then makes available the drive letter to use. This goes in Label2.Caption. The timer attached to this form kicks in, and after the required time (3 seconds), runs the eject. The drive ejects the disc.

Then the form closes and the program halts execution.

A warning is flashed on the screen reading: “Warning This DVD may not be played in a PC-connected drive.” The source code for start.exe indicated below may be inserted into a VisualBasic 6 project, and recompiled as necessary. All the code written for the invention uses sample code freely available at www.microsoft.com, in the MSDN section.

The source code is as follows:

‘-----------------Begin***.exe source, with extra comments---------------

‘Declare the function to run the mciSendString commands

Private Declare Function mciSendString Lib “winmm.dll” Alias “mciSendStringA” (ByVal lpstrCommand As String, ByVal lpstrReturnString As String, ByVal uReturnLength As Long, ByVal hwndCallBack As Long) As Long
Private Sub Form_Load( )
Label2.Visible=False
MainOpen.Show
Me.Timer1.Enabled=True
Dim fso, d, dc, s, n
Dim CurrPath
Dim progpath
Dim drivepath
Dim myFile
progpath=“\start.exe”
‘progpath=“\open\cdo2.exe” ‘used for testing only
‘loop through all the drives in turn
‘determine whether it is a DriveType of CD/DVD
‘if yes, see if the program exists (Start.exe)
‘if yes, then run the eject routine
Set fso=CreateObject(“Scripting.FileSystemObject”)
Set dc=fso.Drives
For Each d In dc
Select Case d.drivetype
Case Is=4
drivepath=d
CurrPath=drivepath & progpath' & Left(d, 1)
On Error Resume Next
myFile=Dir(drivepath & progpath)
Select Case myFile
Case “start.exe”
Me.Label2.Caption=d
On Error GoTo erropendrive
erroropendrive.Raise
Case Else
‘do nothing
End Select
End Select
Next
erropendrive:
MyCurrPath=Label2.Caption ‘what drive to open
End Sub
‘when the timer fires, (4000 ms) run this eject sequence
Private Sub Timer1_Timer( )
EjectMe
Unload Me
End Sub
‘first, we must ‘open’ the drive
‘then, pop open the door
‘then, ‘clean up and close the drive (not the door)
Private Sub EjectMe( )
Dim openString
Dim doorString
Dim closeString
openString=“open cdaudio!” & Label2.Caption & “alias drive” & Left(Label2.Caption, 1)
doorString=“set drive” & Left(Label2.Caption, 1) & “door open wait”
closeString=“close cdaudio!” & Label2.Caption & “alias drive” & Left(Label2.Caption, 1)
mciSendString openString, 0&, 0&, 0&
mciSendString doorString, 0&, 0&, 0&
mciSendString closeString, 0&, 0&, 0&
End Sub

Those skilled in the art will appreciate that various adoptions and modifications of the just described preferred embodiment can be configured without departing from the scope and spirit of the invention. Therefore, it is to be understood that, within the scope of the appended claims, the invention may be practiced other than as specifically described herein.

1. A method of conducting marketing research using DVD technology, the steps comprising:
recruiting respondents to participate in market research evaluation of a program and entering a prize drawing;
sending a package to each of the recruited respondents, said package including a DVD containing a program and commercials to be evaluated and code numbers to access said program and said commercials on said DVD, said package further including instructions for respondents to read and prize drawing books to filled out by said respondents;
viewing said program in said DVD by accessing said DVD with said secured codes by said respondent in one sitting;
filling out program evaluations by said respondent;
calling each said respondent to verify said program was viewed correctly and to ask survey questions to each said respondent and requesting each said respondent view additional information said DVD;
supplying each said respondent agreeing to view said additional information on said DVD with new security code to access said new information on said DVD;
asking each said respondent agreeing to view additional information said DVD abut said new information after said viewing; and
mailing back said DVD and filled out prize books.

2. The method according to claim 1 wherein said secured codes demographically identify the user and determine whether said user is to view a program or advertisements.

3. The method according to claim 1 wherein said secured codes determine whether said user views advertisements after said program.

4. The method according to claim 3 wherein said secured codes determine which advertisements said viewer views after a first segment of said program.

5. The method according to claim 3 wherein said secured codes determine which advertisements said viewer views after a second segment of said program.

6. The method according to claim 3 wherein said secured codes determine which advertisements said viewer views after a third segment of said program.

7. The method according to claim 1 wherein said DVD is programmed to be ejected if played on a Personal computer (PC) connected drive in order to prevent the DVD from being copied and played later.

8. A kit for conducting marketing research using DVD technology, comprising:
recruiting respondents to participate in market research evaluation of a program and entering a prize drawing;
a package including a DVD containing a program and commercials to be evaluated and code numbers to access said program and said commercials on said DVD, said package further including instructions for respondents to read and prize drawing books to be filled out by respondents agreeing to participate in said evaluation;
Secured codes to be entered by said respondents for accessing said DVD in order to view said program and said commercials in said DVD in one sitting;
program evaluations filled out by said respondent after viewing said program and said commercials in said DVD;
questions for each said respondent to verify said program was viewed correctly and to ask survey questions to each said respondent and requesting that each said respondent view additional information on said DVD;
new security code to access said new information on said DVD supplied to each said respondent agreeing to view said additional information on said DVD;
questions for each said respondent agreeing to view additional information on said DVD about said new information after said viewing; and
means for returning said DVD and filled out prize books.

9. The kit according to claim 8 wherein said secured codes demographically identify the user and determine whether said user is to view a program or advertisements.

10. The kit according to claim 8 wherein said secured codes determine whether said user is to view advertisements after said program.

11. The kit according to claim 10 wherein said secured codes determine which advertisements said viewer views after a first segment of said program.

12. The kit according to claim 10 wherein said secured codes determine which advertisements said viewer views after a second segment of said program.

13. The method according to claim 10 wherein said secured codes determine which advertisements said viewer views after a third segment of said program.

14. The method according to claim 8 wherein said DVD is programmed to be ejected if played on a Personal computer (PC) connected drive in order to prevent the DVD from being copied and played later.
